(19) United States
(12) Patent Application Publication
(10) Pub. No.: US 2022/0143890 A1
(43) Pub. Date: May 12, 2022

(54) FIN BLOCK WITH INTERNAL TEMPERATURE CONTROL

(71) Applicant: KRAUSSMAFFEI TECHNOLOGIES GMBH, Munchen (DE)

(72) Inventors: Michael ESSWEIN, Neufahrn (DE); Walter BREUNING, Bergkirchen (DE); Aron ALTMANN, Munchen (DE)

(21) Appl. No.: 17/434,662

(22) PCT Filed: Nov. 26, 2019
(86) PCT No.: PCT/EP2019/082511

§ 371 Date: Aug. 27, 2021

(30) Foreign Application Priority Data
Mar. 21, 2019 (DE) 10 2019 002 004.9

(51) Int. Cl. B29C 48/90; B33Y 80/00

(52) U.S. Cl. CPC B29C 48/901; B33Y 80/00; B33Y 50/00; B29C 48/908; B29C 48/907

(57) ABSTRACT

A fin block is provided for a calibrating device for calibrating an extruded profile, wherein the fin block includes a fin structure, which has a plurality of fins. The fins are spaced apart from one another by grooves and are arranged in longitudinal direction (L) of the fin block. The fin block has at least one channel for feeding a temperature-control fluid, wherein the at least one channel is formed in an integrated manner in the fin block. Furthermore, a method is provided for the production of the above-mentioned fin block, and a calibrating device which includes a plurality of the above-mentioned fin blocks. Furthermore, a system for the additive manufacture of the above-mentioned fin block, a corresponding computer program and a corresponding data set is provided.

The invention relates to a fin block for a calibrating device for calibrating an extruded profile. The invention further relates to a method for the production of such a fin block, a system for the additive manufacture of such a fin block and a corresponding computer program and data set.

Calibrating devices are used for the calibration of extruded endless profiles, such as for example tube profiles. In the production of such profiles, firstly a desired plastic melt is produced for the production of the profile in an extruder. The produced plastic melt is then pressed through an outlet nozzle of the extruder, which prescribes the shape of the profile. The profile exiting from the outlet nozzle of the extruder then passes through a calibrating device, which post-forms the still heated profile with dimensional accuracy.

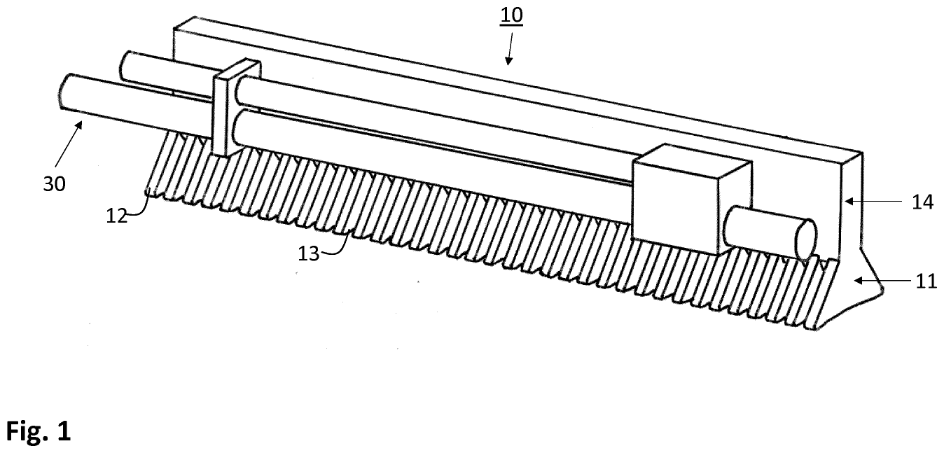

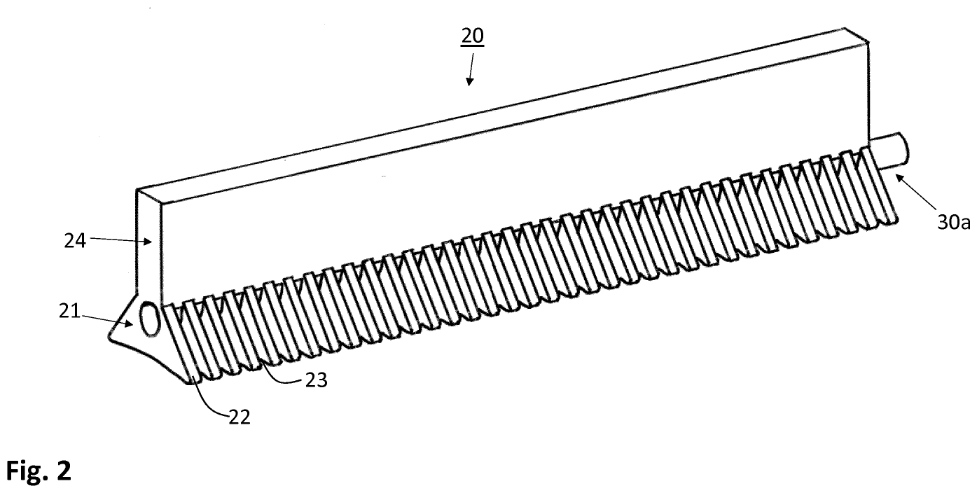

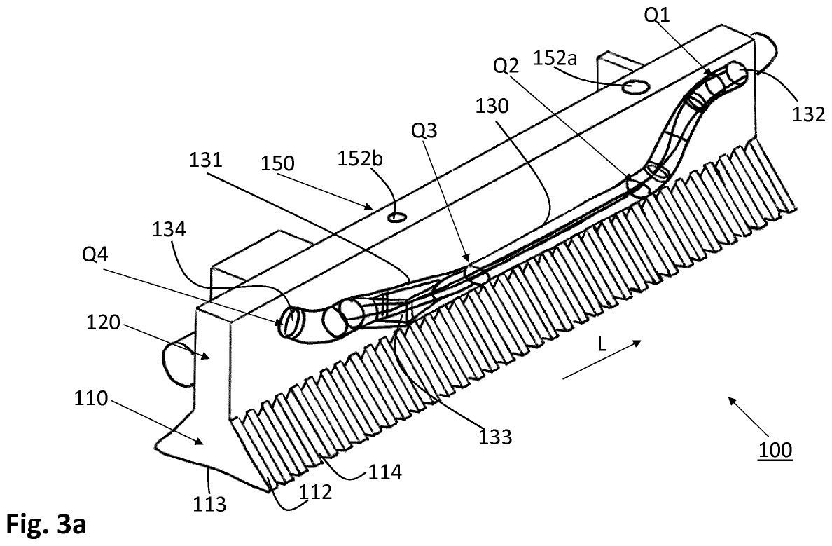

Such a calibrating device for the dimensioning of extruded profiles is known from DE 198 43 340 C2. There, a variably adjustable calibrating device is taught, which is configured for the calibration of extruded plastic tubes with different tube diameter. The calibrating device comprises a housing and a plurality of fin blocks arranged in a circular shape in the housing, the fins of which can engage into one another. The fin blocks, engaging into one another, form a calibration basket with a circular calibration opening, through which the tubes which are to be calibrated are directed (cf. in particular FIGS. 1 and 2 of DE 198 43 340 C2). Furthermore, each fin block is coupled with an actuating device which is provided for the individual radial displacement of the respective fin block. In this way, the effective cross-section of the circular calibration opening formed by the plurality of fin blocks can be adjusted accordingly, as required.

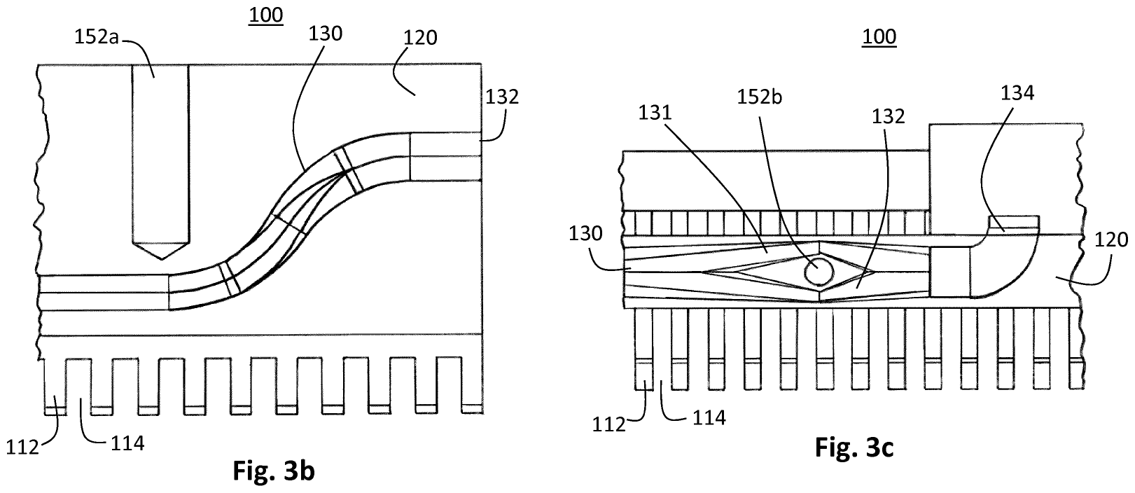

The fin blocks described in DE 198 43 340 C2 consist respectively of a plurality of fins which are strung on two carrier rods arranged spaced apart from one another. To maintain a desired distance between adjacent fins, spacer sleeves are used (cf. also FIG. 3 of DE 198 43 340 C2).

Differing from the strung fin blocks described above, in addition fin blocks with closed carrier structures (or respectively back structures) are known. FIG. 1 shows an example of such a fin block. The fin block 10 comprises a fin structure 11 and a carrier structure 14 configured in a block-shaped manner. The fin structure 11 comprises a plurality of fins 12 which are spaced apart from one another by grooves 13 and are arranged along the carrier structure 14. The block-shaped carrier structure 14 is realized here in the form of a solid body (e.g. a bar-shaped body). Furthermore, the carrier structure 14 is configured in one piece with the fins 12. The fin block 10 further comprises a tubular cooling water feed 30, mounted externally on the carrier structure 14. Cooling water for cooling the fins 12 can be directed through the cooling water feed 30. Cooling water can be sprayed onto the fins 12, or respectively onto the product which is to be calibrated, via spray openings on the cooling water feed. A disadvantage of the external cooling water feed 30 shown in FIG. 1 is that this is relatively complex to realize.

In connection with FIG. 2, a further example of a known fin block 20 is illustrated. The fin block 20 has, again, a carrier structure 24 and a fin structure 21. The fin structure 21 comprises a plurality of fins 22, which are spaced apart from one another by grooves 23 and are arranged along the carrier structure 24. The carrier structure 24 and the fins 22 are configured substantially identically as in the fin block design shown in FIG. 1. The essential difference between the fin block design in FIG. 1 and that in FIG. 2 consists in the arrangement of the cooling water feed. In the fin block design shown in FIG. 2, the cooling water feed 30a is configured in the form of a pipe with spray openings, which is arranged at the transition between the carrier structure 24 and the fin structure 22. The cooling water feed 30a concerns a thermally separated, internal cooling water feed, because the cooling water directed in the pipe is separated from the fin block by the pipe casing.

The disadvantage of the cooling water feeds 30, 30a shown in FIGS. 1 and 2 lies in that the fin blocks 10, 20 do not undergo any appreciable cooling/temperature control by the cooling water through the cooling water feeds 30, 30a themselves. Rather, the fin blocks 10, 20 are cooled or respectively temperature-controlled only through the spray water and the splashing in a cooling water sump of a calibration basket.

It is therefore the object of the present invention to provide a fin block for a calibrating device, which further reduces or respectively eliminates the problems indicated in connection with the prior art. In particular, it is the object of the present invention to provide a fin block which provides an improved temperature control (cooling) of the fin block.

To solve the above-mentioned problem, a fin block is provided for a calibrating device for calibrating an extruded plastic profile. The fin block comprises a fin structure which has a plurality of fins which are spaced apart from one another by grooves and are arranged in longitudinal direction of the fin block. The fin block has at least one channel for the feeding of a temperature-control fluid, wherein the at least one channel is formed in an integrated manner in the fin block.

A channel formed in an integrated manner in the fin block can mean that the at least one channel is formed in the interior of the fin block. The at least one channel can be formed as an (elongated) cavity in the interior of the fin block. The cavity is surrounded (delimited) in circumferential direction by the fin block. Thereby, the cavity is in direct contact with the fin block. The cavity does not have an independent casing. Through the direct contact of the fin block with the cavity (channel), a direct thermal coupling is enabled between the temperature-control fluid which is directed in the channel and the environment of the fin block. Therefore, the fin block can be temperature-controlled (cooled or heated) in an efficient manner via the at least one channel.

The at least one channel can have one or several spray openings. When several spray openings are provided, these can be arranged in a distributed manner along the channel. Each spray opening can be configured in such a way that it only allows a portion of the fluid, directed in the channel, to exit for controlling the temperature of the fin block. The spray openings can have variable opening cross-sections for this. The shape and dimensions of the opening cross-sections can vary from opening to opening. Therefore, different partial flows can be withdrawn along the fin block for temperature control (of the fins or respective of the product which is to be calibrated).

The at least one channel can be formed within the fin block in such a way that it follows at least one predetermined path. The at least one path can be configured so as to be rectilinear and/or curved. Therefore, the at least one channel can be formed running within the fin block in a rectilinear and/or curved manner.

The at least one channel can, furthermore, be configured in such a way that the at least one channel (transversely to the path direction) has a variable cross-section. The cross-section of the at least one channel can vary continuously (discontinuously) along the path. The variation of the cross-section along the path can depend here on the constitution of the fin block. The shape and/or dimension (diameter) of the channel cross-section can be adapted to the dimensions of the fin block, in which the at least one channel is integrated.

The channel can have any desired shape in cross-section. The cross-sectional shape of the channel can be circular, elliptical, rectangular or have an otherwise polygonal shape.

According to a variant, the at least one channel can be configured in a loop-like manner in the fin block. The at least one channel can form one or several loops here. A loop-like configuration of the at least one channel can contribute to a more effective temperature control (cooling or heating) of the fin block.

The at least one channel can, furthermore, be configured in such a way that at a predetermined first position in the fin block it divides itself into two or more partial channels. Equally, the two or more partial channels can unite again to form one channel at a predetermined second position in the fin block.

The division of a channel into two or more partial channels can depend on the dimensions and on the design of the fin block. In particular, a channel division into several partial channels with a respectively smaller channel cross-section can be expedient in order to guide the channel around fin portions which must not be penetrated by the channel (for example threaded bores formed in the fin block).

The at least one channel can be part of a temperature-control circuit. A temperature-control circuit can mean a closed or open circuit in which temperature-control fluid (such as water, for example) circulates for cooling and/or heating the fin block. Therefore the channel, as part of the temperature-control circuit, can be provided to cool or respectively heat the fin block or respectively the fins of the fin block to a predetermined desired temperature.

The fin block can, furthermore, have a carrier structure on which the fins of the fin structure are fastened. Furthermore, the at least one channel can be formed in an integrated manner in the carrier structure. Formed in an integrated manner can mean that the at least one channel is formed within the carrier structure.

The carrier structure can be formed in one piece with the fins or respectively with the fin structure. Alternatively, the fin structure or respectively the fins and the carrier structure can be manufactured respectively separately. The fin structure or respectively fins can then be connected with the carrier structure accordingly.

The carrier structure and the fins can be made from the same material or from different materials. According to a variant, the material from which the carrier structure and/or the fins are made can be made from a metallic material. However, the use of a polymer material (with additives) is also conceivable.

The fin block described above is preferably produced by means of 3D printing. The use of a 3D printing technique enables a favourably-priced and quick production of fin blocks, wherein any desired channel geometry is able to be realized.

According to a further aspect of the invention, a calibrating device is provided for the calibrating of extruded plastic profiles, wherein the calibration device has a plurality of fin blocks according to the invention, which are arranged for the formation of a calibration opening with respect to one another. The arrangement of the fin blocks can be in such a way here that these form a circular calibration opening.

The calibrating device can comprise a temperature-control circuit for the feeding of temperature-control fluid. The temperature-control circuit can comprise a device for the provision of temperature-control fluid and a duct system for feeding the provided temperature-control fluid to the individual fin blocks. The duct system can be fluidically coupled with the channels of the fin blocks. The channels can thus be part of the temperature-control circuit.

The calibrating device can comprise, furthermore, a plurality of actuating devices, wherein each actuating device is coupled respectively with a fin block, in order to actuate each fin block individually. Through the actuating device, each fin block can be actuated individually radially to the calibration opening. Thereby, the effective cross-section of the calibration opening can be adapted, as required, to the cross-section (diameter) of the profile which is to be calibrated.

Furthermore, the calibrating device can have a housing which is provided to receive and store the actuating device and the fin blocks which are coupled with the actuating device.

According to a further aspect of the invention, a method is provided for producing a fin block as described above. The method for producing the fin block comprises at least the step of producing the fin block by means of 3D printing or by means of additive manufacture. The production of the fin block by means of 3D printing method or additive manufacture method can comprise here a layer by layer laser sintering or laser melting of material layers, wherein the material layers are applied in succession (sequentially) according to the shape of the fin block which is to be produced.

The method can further comprise the step of calculating a 3D fin block geometry (CAD data). Furthermore, the method can comprise the step of converting the 3D geometry data into corresponding control commands for the 3D printing.

The step of calculating a 3D fin block geometry can comprise the step of calculating a channel geometry (channel cross-section, channel course along a path) and the arrangement of the channel within the fin block. The calculation of channel geometry and channel arrangement can take place taking into consideration the constitution of the fin block (block geometry, block material, cooling requirement). In particular, the geometry and arrangement of the at least one channel can be adapted to the constitution of the fin block.

According to a further aspect, a method is provided for producing a fin block, which comprises the steps: establishing a data set which represents the fin block as described above, and storing of the data set on a storage device or a server. The method can furthermore comprise: inputting of the data set into a processing device or a computer, which actuates a device for additive manufacture in such a way that it manufactures the fin block represented in the data set.

According to a further aspect, a system is provided for additive manufacture of a fin block, with a data set generating device for generating a data set, which represents the fin block as described above, a storage device for storing the data set and a processing device for receiving the data set and for actuating a device for additive manufacture in such a way that it manufactures the fin block which is represented in the data set. The storage device can be a USB stick, a CD-ROM, a DVD, a memory card or a hard disk. The processing device can be a computer, a server or a processor.

According to a further aspect, a computer program or respectively a computer program product is provided, comprising data sets which, with the reading of the data sets by a processing device or a computer, causes it to actuate a device for additive manufacture in such a way that the device for additive manufacture manufactures the fin block as described above.

According to a further aspect, a machine-readable data carrier is provided, on which the computer program, which is described above, is stored. The machine-readable data carrier can be a USB stick, a CD-ROM, a DVD, a memory card or a hard disk.

According to a further aspect, a data set is provided, which represents the fin block as described above. The data set can be stored on a machine-readable data carrier.

Further advantages, details and aspects of the present invention are discussed further with the aid of the following drawings. There are shown:

FIG. 1 a fin block for a calibrating device according to the prior art;

FIG. 2 a further fin block for a calibrating device according to the prior art;

FIGS. 3a-3c views of a fin block according to the present invention;

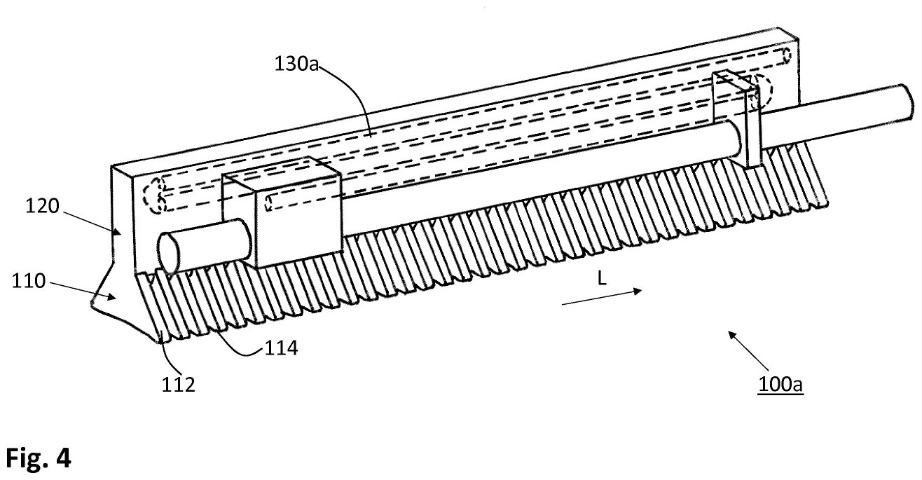

FIG. 4 a view of a further fin block according to the present invention;

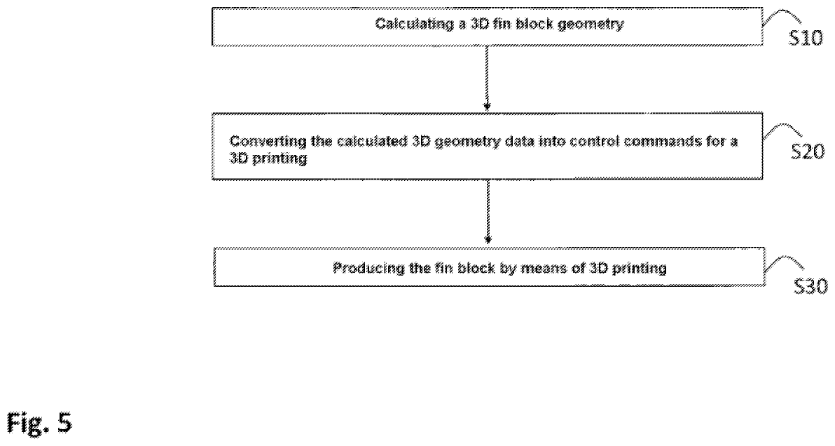

FIG. 5 a block diagram of a method for the production of the fin block according to the invention; and

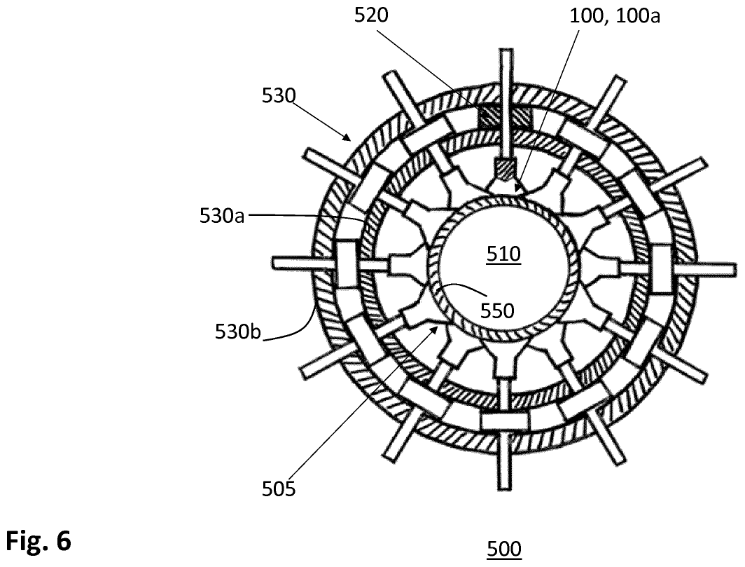

FIG. 6 a sectional view of a calibrating device according to the present invention.

FIGS. 1 and 2 were already discussed in the introduction in connection with the prior art. Reference is to be made to the description there.

In connection with FIGS. 3a and 3b, an example of a fin block 100 according to the invention is now described in further detail.

The fin block 100 comprises a carrier structure 120 and a fin structure 110, which has a plurality of fins 112. The carrier structure 120 functions as a carrier for the fin structure 110. Furthermore, the fin block 100 comprises at least one channel 130. The at least one channel 130 is described in further detail below.

In the following, the fin structure 110 of the fin block 100 is now described further. The fin structure 110 comprises a plurality of fins 112, which are arranged spaced apart from one another in longitudinal direction L of the fin block 100 (see FIG. 3a). Adjacent fins 112 are separated from one another by corresponding grooves 114. Each fin 112 has a triangular profile in cross-section to the longitudinal direction L. Furthermore, each fin 112 has a fin surface 113 facing away from the carrier structure 120, which fin surface is formed so as to be slightly curved. The fin surface 113 faces the profile which is to be calibrated. It forms the contact surface with the profile which is to be calibrated. Depending on the application, the fin block 100 can also have a different fin shape, which can differ from the triangular cross-section profile which is described here. Likewise, the fin surface 113 facing the profile which is to be calibrated can be flat or can have a different curvature.

The carrier structure 120 is formed as a solid body (block) (designated carrier block 120 in the following). The carrier block 120 has a rectangular profile in cross-section perpendicularly to the longitudinal direction L. Other profiles, differing from a rectangular cross-section profile, are likewise conceivable. The carrier block 120 has, furthermore, on its side lying opposite the fins, two threaded bores 152a, 152b. The threaded bores 152a, 152b are part of a coupling device 150, which is provided to couple the fin block 100 with a corresponding actuating device of the calibrating device. The actuating device of the calibrating device is not illustrated in FIG. 3a.

The carrier block 120 is formed in one piece with the fin structure 110. Alternatively hereto, it is also conceivable that the fins of the fin structure 110 are formed as separate elements. In such a case, the fins 112 are arranged accordingly in longitudinal direction L on the side of the fin block 100 facing the profile which is to be calibrated, and are connected accordingly with the carrier block 120 (e.g. by welding, bonding).

As can be seen further from FIG. 3a, the fin block 100 has a channel 150, which is formed running in the interior of the carrier block 120. The channel 130, running in the interior of the carrier block 120, has two opposite outlet openings 132, 134. The first outlet opening 132 is arranged on a first face side of the carrier block 120, whereas the second outlet opening 134 is arranged on a lateral side of the carrier block 120 or on a second face side of the carrier block 120 lying opposite the first face side. At the two outlet openings 132, 134, connection elements can be provided, which are formed for fluidic coupling with a temperature-control circuit.

The channel 130 arranged in the interior of the carrier block 120 has a predetermined channel course between its two outlet openings 134. The channel course can be configured in such a way that the channel 130 has, in longitudinal direction L, portions with a rectilinear course and portions with a curved course.

The channel course shown in FIG. 3a is only by way of example. The channel 130 can follow any desired path between its two outlet openings 132, 134. The channel course can conform to the structural conditions of the carrier block 120 receiving the channel 130. In particular, the channel 130 can change its direction within the carrier block 120 and/or can have a division into two or more partial channels 131, 133, in order for example to bypass an obstacle.

This circumstance is clarified further in connection with FIGS. 3b and 3c. FIG. 3b shows an enlarged sectional view of the fin block 100 which is illustrated in FIG. 3a. The sectional view presents only the fin block region in the vicinity of the bore 152a. The course of the channel 130 is configured in a curved manner in the environment of the bore 152a. Through the curved course, the channel 130 can be guided around the bore 152a.

FIG. 3c shows an enlarged top view onto the fin block 100 illustrated in FIG. 3a. The view in FIG. 3c represents only the fin block region in the vicinity of the bore 152b. As can be seen from FIG. 3c, the channel 150 divides itself in the vicinity of the bore 152b into two partial channels 131, 133, which encircle the bore 152b. Through the splitting of the channel 130 into two partial channels 131, 133 with a respectively smaller channel cross-section, the bore 152b can be bypassed without difficulty. The sum of the cross-sections of the two partial channels 131, 133 can be insignificantly smaller here than the cross-section of the channel 130 before and after the division. Therefore, it is ensured that the temperature-control fluid can flow through the channel 130 without appreciable resistance.

Returning to FIG. 3a. As further indicated in FIG. 3a by way of example, the channel 130 formed in the carrier block 120 can have variable cross-sections Q1, Q2, Q3, Q4. The channel 130 has at and in the vicinity of its first outlet opening 132 and at and in the vicinity of its second outlet opening 134 respectively a circular cross-section (cf. FIG. 3a, channel cross-sections Q1 and Q4). Therebetween, the channel 130 has partially elliptical cross-sections Q2, Q3. The transition from the circular cross-sections Q1, Q4 to the elliptical cross-sections Q2, Q3 can take place continuously (steplessly). The cross-section variations which are shown along the channel 130 are by way of example. Channels with different cross-section geometries (and cross-section variations) are likewise conceivable.

The channel guiding described here in connection with FIGS. 3a to 3c differs from conventional bores according to the prior art in that the channel 130 is configured so as to be variable in its cross-section geometry and in its channel guiding between the two outlet openings 132, 134. In particular, the channel cross-section and/or the channel guiding within the fin block 100 (carrier block 120) can be adapted (optimized) accordingly to the temperature requirements and to the geometric conditions of the fin block 100 (carrier block 120), in which the channel 130 is received. A further difference from the prior art consists in that the channel 130 is realized as a cavity in the fin block 100 (carrier block 120), which is in direct contact with the environment of the fin block 100 (carrier block 120). Therefore, the temperature fluid which is directed in the cavity can come in direct thermal contact with the fin block 100.

In connection with FIG. 4, a further implementation of a fin block 100a is described. The fin block 100a shows a fin structure 110 and a carrier structure 120, which correspond substantially to the fin structure 110 and carrier structure 120 of the fin block 100 shown in FIGS. 3a-3c. They are therefore given the same reference numbers. Reference is to be made to the corresponding description of FIGS. 3a-3c further above. The essential difference between the fin block 100a in FIG. 4 and the fin block 100 of FIGS. 3a-3b consists in the configuration of the channel 130a. In the variant shown in FIG. 4, the channel 130a is formed so as to be loop-shaped. It has two loops. Through the loop-shaped formation, a particularly good thermal coupling is realized between the temperature-control fluid circulating in the channel 130a and the carrier block 120.

For the production of the fin blocks 100, 100a, described above, with at least one channel for the directing of temperature-control fluid, a generative or respectively additive manufacturing method can come into use. Such a production method is shown in FIG. 5 and is described in further detail below.

Accordingly, a 3D printing method comes into use. Here, in a first step S10, a 3D fin block geometry (CAD data) is calculated. The 3D fin block geometry or respectively the CAD data describing the 3D fin block geometry describe inter alia also the geometry and the course of the at least one channel 130, 130a which is to be formed in the fin block. The geometry and the course of the at least one channel 130, 130a which is to be formed in the fin block (carrier block) can be calculated individually for each fin block, taking into consideration predetermined model parameters (such as for example the geometry of the fin block, material of the fin block, thermal characteristics of the fin block.

In a subsequent second step S20, the calculated 3D geometry data are converted into control commands for operating a 3D printing device. The 3D printing device can be designed for carrying out a 3D printing method (e.g. a laser sintering method or laser melting method).

Based on the generated control commands, the fin block 100 is then built up layer by layer by means of the 3D printing device (step S30). A metallic material or a polymer material can come into use as material for the 3D printing.

The 3D printing method which is described here for the production of the fin blocks 100, 100a according to the invention is advantageous because according to the temperature control requirement or other requirements, one or more channels with variable geometry and with variable course can be realized. The at least one channel does not have to remain restricted to uniform circular bores, but rather can be configured variably depending on a temperature control requirement (cooling requirement or heating requirement). The course and the geometry of the at least one channel for each fin block can be adapted to the geometrical conditions of the fin block in such a way that the block undergoes an effective cooling/heating.

In connection with FIG. 6, a calibrating device 500 is described for calibrating an extruded plastic profile 550. FIG. 6 shows a sectional view of the calibrating device 500. In the implementation shown in FIG. 6, the profile 550 which is to be calibrated is a tube profile.

The calibrating device 500 comprises a plurality of the fin blocks 100 according to the invention, described above, which are arranged in circumferential direction of the calibrating device 500 with respect to one on another in such a way that they form a calibration basket 505 with a desired calibration opening 510. As further indicated schematically in FIG. 5, the adjacent fin blocks 100 can be arranged engaging into one another. For this, the fins 112 and grooves 114 of adjacent fin blocks 100 are coordinated with one another in their arrangement and dimension (in particular in the groove width and fin width) in such a way that the fins 112 of adjacently arranged fin blocks 100 can engage into one another in a comb-like manner.

Furthermore, the calibrating device 500 comprises a plurality of actuating devices 520 (for example linear actuators), wherein respectively an actuating device 520 is coupled with a fin block 100. The actuating devices 520 are provided to displace the respective fin blocks 100 in radial direction (therefore perpendicularly to the feed direction of the profile which is to be calibrated). Thereby, the effective cross-section of the calibration opening 510 can be adapted accordingly to the profile 550 which is to be calibrated.

Furthermore, the calibrating device 500 comprises a housing 530 for receiving the actuating devices 520 and the fin blocks 100. The housing 530 can be configured so as to be cylindrical. It can have an inner housing cylinder 530a and an outer housing cylinder 530b, wherein components of the actuating device 520 can be arranged in the intermediate space between the inner housing cylinder 530a and the outer housing cylinder 530b, similarly to the calibrating device described in DE 198 43 340 C2.

The flexible configuration, described here, of the channels within the fin block enables an efficient thermal coupling between the temperature-control fluid and the fin block 100. Through the fact that the fin block 100 is produced by means of 3D printing, every possible configuration and variation of the channel is possible within the fin block. Alongside the more effective cooling through the channel design which is described here, furthermore a more compact design is enabled compared to the prior art.

What is claimed is:

1.-20. (canceled)

21. A fin block (100, 100a) for calibrating an extruded profile (550) within a calibrating device (500), wherein the fin block (100, 100a) comprises a fin structure (110), which has a plurality of fins (112) which are spaced apart from one another by grooves (114) and are arranged in longitudinal direction (L) of the fin block (100, 100a), wherein the fin block (100, 100a) has at least one channel (130, 130a) for feeding a temperature-control fluid, wherein the at least one channel (130, 130a) is formed in an integrated and loop-like manner in the fin block (100, 100a), and wherein the fin block (100, 100a) is formed in one piece.

22. The fin block (110, 100a) according to claim 21, wherein the at least one channel (130, 130a) is formed within the fin block (100) in such a way that the at least one channel (130, 130a) follows a predetermined path.

23. The fin block (100, 100a) according to claim 21, wherein the at least one channel (130, 130a) has a variable cross-section.

24. The fin block (100, 100a) according to claim 21, wherein the at least one channel (130, 130a) in the fin block (100, 100a) divides itself at a predetermined first position in the fin block (100, 100a) into two or more partial channels (131, 133).

25. The fin block (100, 100a) according to claim 4, wherein the two or more partial channels (131, 133) unite again to form one channel at a predetermined second position in the fin block (100, 100a).

26. The fin block (100, 100a) according to claim 21, wherein the fin block (100, 100a) has, furthermore, a carrier structure (120) on which the fins (112) of the fin structure (110) are fastened, wherein the at least one channel (130, 130a) is formed in the carrier structure (120).

27. The fin block (100, 100a) according to claim 21, characterized in that the at least one channel (130, 130a) is part of a temperature-control circuit, wherein the at least one channel (130, 130a) has two opposite outlet openings (132, 134) at which connection elements can be provided, which are formed for the fluidic coupling with the temperature-control circuit.

28. The fin block (100, 100a) according to claim 21, wherein the fin block (100, 100a) is produced by means of 3D printing or respectively by means of an additive manufacturing method.

29. A calibrating device (500) for the calibrating of extruded profiles, comprising a plurality of fin blocks (100) according to claim 21, wherein the fin blocks (100) are arranged with respect to one another for the formation of a calibration opening.

30. The calibrating device (500) according to claim 29, wherein the calibrating device (500) comprises a plurality of actuating devices (520), wherein each actuating device (520) is coupled respectively with a fin block (100, 100a), in order to actuate each fin block (100, 100a) individually.

31. The calibrating device (500) according to claim 29, further comprising a temperature-control device, which is fluidically coupled with the at least one channel (130, 130a).

32. A method for producing a fin block (100) according to claim 21, comprising the step of producing the fin block (100) by means of 3D printing or respectively by means of additive manufacture.

33. The method according to claim 32, further comprising calculating a 3D fin block geometry, and converting the calculated 3D fin block geometry data into corresponding control commands for the 3D printing or respectively the additive manufacture.

34. A method for producing a fin block (100), comprising the steps:
establishing a data set which represents the fin block (100) according to claim 21,
storing the data set on a storage device or on a server; and
inputting the data set into a processing device or a computer, which actuates a device for the additive manufacture in such a way that it manufactures the fin block (100) represented in the data set.

35. A computer program, comprising data sets, which with the reading of the data sets by a processing device or a computer causes it to actuate a device for additive manufacture in such a way that the device for additive manufacture manufactures a fin block (100) having the features according to claim 21.

36. A machine-readable data carrier on which the computer program according to claim 35 is stored.

37. A data set which represents a fin block (100) having the features according to claim 21.
